(19) United States
(12) Patent Application Publication
(10) Pub. No.: US 2013/0340904 A1
(43) Pub. Date: Dec. 26, 2013

(54) PNEUMATIC TIRE AND MANUFACTURING METHOD OF THE SAME

(71) Applicant: TOYO TIRE & RUBBER CO., LTD., (US)

(72) Inventor: Yuji Inoue, Osaka-shi (JP)

(73) Assignee: TOYO TIRE & RUBBER CO., LTD., Osaka (JP)

(21) Appl. No.: 13/685,846

(22) Filed: Nov. 27, 2012

(30) Foreign Application Priority Data
Dec. 19, 2011 (JP) 2011-277608
Sep. 12, 2012 (JP) 2012-200587

(51) Int. Cl. B60C 11/00; B29D 30/08

(52) U.S. Cl. CPC B60C 11/0008; B29D 30/08
USPC 152/209.1; 152/450; 156/117

(57) ABSTRACT

A tread rubber of a pneumatic tire is formed by a ribbon rubber which is spirally wound around a tire rotating axis. The ribbon rubber is wound toward one side in a tire width direction from a start point which is positioned closer to a center side than tread ends in a tire meridian cross section, is next folded back to the other side in the tire width direction at the tread end on the one side, is wound toward the tread end on the other side beyond the start point, is next folded back to the one side in the tire width direction at the tread end on the other side, and is wound toward an end point. The ribbon rubber has the winding start end and the winding terminal end at tread end vicinity portions avoiding the tread ends and a tread center portion.

### BACKGROUND OF THE INVENTION

1. Field of the Invention

The present invention relates to a pneumatic tire having a tread rubber, and a manufacturing method of the same.

2. Description of the Related Art

Conventionally, there has been proposed a so-called ribbon winding construction method which forms a tread rubber by spirally winding an unvulcanized ribbon rubber around a tire rotating axis to an outer peripheral surface of an approximately cylindrical rotation support body, while overlapping a side edge thereof.

As one example of a pneumatic tire in which the tread rubber is formed by the ribbon winding construction method, for example, JP-A-2006-130880 discloses a pneumatic tire structured such that a ribbon rubber is wound from a starting point which is positioned in a center portion of a tread toward one side in a tire width direction in a tire meridian cross section, is next folded back to the other side in the tire width direction in a tread end on the one side, and is wound toward a tread end on the other side beyond the starting point, and a winding start end and a winding terminal end of the ribbon rubber are arranged in a center portion of the tread rubber (in the vicinity of a tire equator).

As the other example of the pneumatic tire which is manufactured by the ribbon winding construction method, JP-A-2002-46194 discloses a pneumatic tire such that a ribbon rubber is wound from a tread end on one side in a tire width direction as a start point toward a tread end on the other side, is next folded back to the one side in the tire width direction at the tread end on the other side, and is wound toward the tread end on the one side, and a winding start end and a winding terminal end of the ribbon rubber are arranged in the tread ends.

### SUMMARY OF THE INVENTION

However, in the pneumatic tire according to JP-A-2006-130880, since the winding start end and the winding terminal end of the ribbon rubber are arranged in the tread center portion, and greater centrifugal force is applied to the center portion of the tread rubber in comparison with the tread end, a failure starting from the winding terminal end tends to be generated in comparison with the case that the winding start point and the winding terminal end exist at the tread ends, and a high-speed durability is deteriorated.

On the other hand, in the pneumatic tire according to JP-A-2002-46194, since the winding start point and the winding terminal end of the ribbon rubber are arranged in the tread ends, and the tread ends are generally formed as a tapered shape, it is hard to appropriately press the ribbon rubber which is wound to a position coming to the tread end by a following roller (stitcher) in a ribbon rubber winding step, and a defect tends to be generated.

The present invention is made by paying attention to the problem mentioned above, and an object of the present invention is to provide a pneumatic tire which suppresses a defect as well as improving a high-speed durability, and a manufacturing method of the same.

The present invention employs the following means for achieving the object.

In other words, according to the present invention, there is provided a pneumatic tire including a tread rubber that is formed by a ribbon rubber which is spirally wound around a tire rotating axis, wherein the ribbon rubber is wound from a start point which is positioned closer to a center side than tread ends toward one side in a tire width direction in a tire meridian cross section, is next folded back to the other side in the tire width direction at the tread end on the one side, is wound toward the tread end on the other side beyond the start point, is next folded back to the one side in the tire width direction at the tread end on the other side, and is wound toward a terminal end which is positioned closer to the center side than the tread ends, and the ribbon rubber has a winding start end and a winding terminal end in the vicinity of the tread ends avoiding the tread ends and the tread center portion.

The vicinity of the tread ends means a range between 5 and 25% of a maximum width of the tread rubber from the tread ends toward the center side.

As mentioned above, since the winding start end and the winding terminal end of the ribbon rubber are arranged in the vicinity of the tread end avoiding the tread center portion, an influence of the centrifugal force is reduced in comparison with the case that the winding start end and the winding terminal end are arranged in the tread center portion, and it is possible to improve the high-speed durability. All the same time, since the winding start end and the winding terminal end are arranged in the vicinity of the tread end avoiding the tread ends, it is possible to appropriately press the ribbon rubber at the winding time, and it is possible to suppress a defect.

In order to suppress the failure caused by the heat generation, and further improve the high-speed durability, it is effective that the winding terminal end of the ribbon rubber is arranged at a position at which a main groove extending in a tire peripheral direction is formed. According to the structure, at the forming position of the main groove, a thickness of the rubber becomes thinner, and the heat generation at the time of the high-speed rotation is suppressed in conjunction therewith. Therefore, it is possible to suppress the failure caused by the heat generation, and it is possible to improve the high-speed durability.

In the case that a tire having a thick tread rubber, for example, a tire for a truck and a tire for a bus is manufactured according to the ribbon winding construction method, it is often the case that a winding pitch of the ribbon rubber is narrowed and the ribbon rubber is set to a rising state. However, since it becomes hard to control the winding in conformity to the rising of the ribbon rubber, securing a thickness of the tread rubber comes to a hard work.

Consequently, in order to easily secure the thickness of the tread rubber, it is preferable that the tread rubber has a three-layer structure portion in which the ribbon rubber wound toward the one side in the tire width direction is folded back, is wound toward the other side in the tire width direction, is thereafter folded back again and is wound toward the one side in the tire width direction, at the position closer to the center side than the tread ends. Since the tire having the three-layer structure mentioned above can be manufactured without narrowing the winding pitch of the ribbon rubber as well as raising the ribbon rubber, on the contrary, even in a state in which the winding pitch of the ribbon rubber is widened and the ribbon rubber is laid down, it is possible to easily secure the thickness of the tread rubber.

In order to realize the securing of the thickness of the tread rubber and a winding controllability of the ribbon rubber, it is preferable that the ribbon rubber forms a first layer which has the vicinity portion of the tread end on the one side in the tire width direction as a start point, among the vicinity portions of the pair treads to the tread end on the other side in the tire width direction, next forms a second layer which is folded back to the one side in the tire width direction at the tread end on the other side in the tire width direction and reaches the tread end on the one side beyond the start point, and next forms a third layer which is folded back to the other side in the tire width direction at the tread end on the one side and has the vicinity portion of the tread end on the other side in the tire width direction as a terminal end.

The pneumatic tire mentioned above is manufactured by a manufacturing method described below. In other words, according to the present invention, there is provided a manufacturing method of a pneumatic tire, including a tread rubber forming step of forming a tread rubber by spirally winding a ribbon rubber around a tire rotating axis,

wherein the tread rubber forming step includes a stage of winding the ribbon rubber from a start point which is positioned closer to a center side than tread ends in a tire meridian cross section toward one side in a tire width direction, next folding back the ribbon rubber to the other side in the tire width direction at the tread end on the one side, winding the ribbon rubber toward the tread end on the other side beyond the start point, next folding back the ribbon rubber to the one side in the tire width direction at the tread end on the other side, and winding the ribbon rubber toward a terminal end which is positioned closer to the center side than the tread ends, and the ribbon rubber has a winding start end and a winding terminal end in the vicinity portion of the tread end avoiding the tread end and the tread center portion.

According to the manufacturing method, since the tread rubber can be formed by one winding process without disconnecting the ribbon rubber from the start point to the terminal end, it is possible to improve a forming efficiency of the tread rubber. Further, as mentioned above, it is possible to improve the high-speed durability, and it is further possible to suppress the defect.

In order to further improve the high-speed durability, it is preferable to arrange the winding terminal end at the forming position of the main groove extending in the tire peripheral direction.

In order to easily secure the thickness of the tread rubber, it is desirable to form the three-layer structure portion by folding back the ribbon rubber which is wound toward the one side in the tire width direction, at the position which is closer to the center side than the tread ends, winding the ribbon rubber toward the other side in the tire width direction, and thereafter folding back the ribbon rubber again so as to wind toward the one side in the tire width direction.

In order to realize the securing of the thickness of the tread rubber and the winding controllability of the ribbon rubber, it is preferable to form a first layer by moving the winding position of the ribbon rubber to the tread end on the other side in the tire width direction from the start point of the vicinity portion of the tread end on the one side in the tire width direction, among the vicinity portions of the pair treads, next form a second layer by folding back the winding position of the ribbon rubber to the one side in the tire width direction at the tread end on the other side in the tire width direction and moving to the tread end on the one side beyond the start point, and next form a third layer by folding back the winding position of the ribbon rubber to the other side in the tire width direction at the tread end on the one side and defining the vicinity portion of the tread end on the other side in the tire width direction as a terminal end.

### BRIEF DESCRIPTION OF THE DRAWINGS

FIG. 1 is a tire meridian cross sectional view showing a pneumatic tire according to an embodiment of the present invention;

FIG. 2 is a view showing a manufacturing facility which is used in a forming step of a tread rubber;

FIG. 3 is a schematic cross sectional view of a ribbon rubber;

FIGS. 4A-4D are cross sectional views schematically showing a forming step of the tread rubber;

FIG. 5 is a plan view showing a winding process of the ribbon rubber;

FIG. 6 is a conceptual view showing a moving route of a ribbon winding position;

FIGS. 7A-7C are cross sectional views showing a winding process of the ribbon rubber;

FIG. 8 is a conceptual view showing the other moving route of the ribbon winding position;

FIG. 9 is a conceptual view showing a different moving route from the above route of the ribbon winding position;

FIG. 10 is a conceptual view showing a different moving route from the above route of the ribbon winding position;

FIG. 11 is a conceptual view showing a different moving route from the above route of the ribbon winding position; and

FIG. 12 is a conceptual view showing a different moving route from the above route of the ribbon winding position.

### DETAILED DESCRIPTION OF THE PREFERRED EMBODIMENTS

An embodiment of the present invention will be described blow with reference to the accompanying drawings. First of all, a description will be given of a structure of a pneumatic tire according to the present invention, and a description will be given next of a manufacturing method of the pneumatic tire according to the present invention.

### [Structure of Pneumatic Tire]

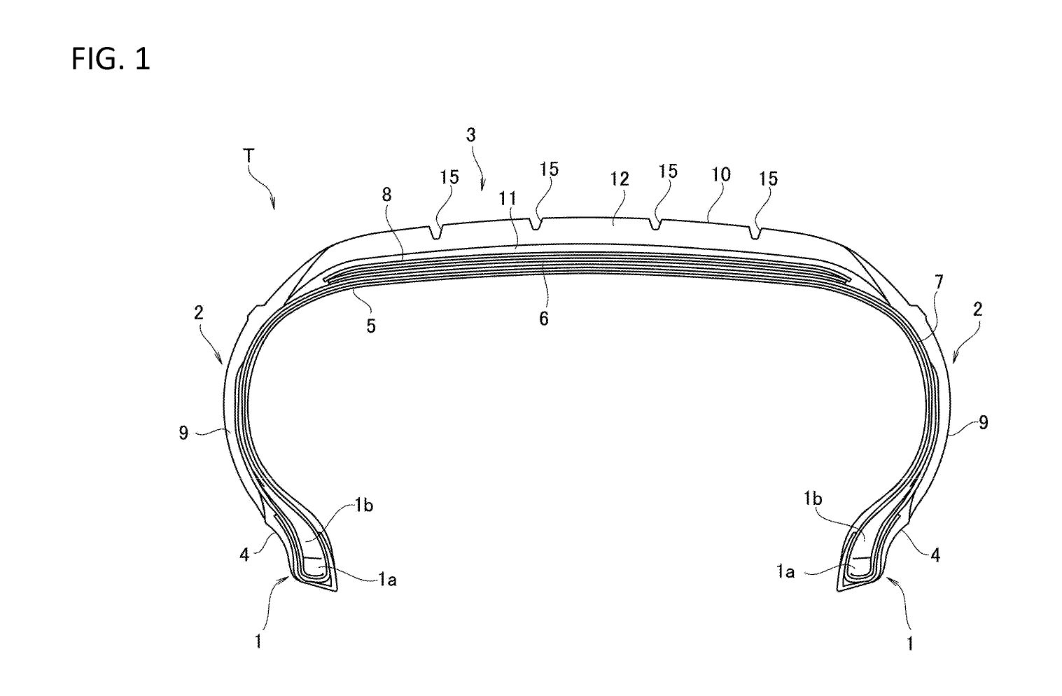

A pneumatic tire T shown in FIG. 1 is provided with a pair of bead portions 1, side wall portions 2 each of which extends to an outer side in a tire diametrical direction from each of the bead portions 1, and a tread portion 3 which is connected to an outer end in the tire diametrical direction of each of the side wall portions 2. An annular bead core 1a formed by coating a converged body of steel wires with a rubber, and a bead filler 1b made of a hard rubber are arranged in the bead portion 1.

A toroidal carcass layer 7 is arranged between a pair of bead portions 1, and an end portion thereof is locked in a state of being wound up via the bead core 1a. The carcass layer 7 is constructed by at least one (two in the present embodiment) carcass ply, and the carcass ply is formed by coating a cord extending at an angle of about 90 degrees with respect to the tire peripheral direction with a topping rubber. An inner liner rubber 5 for retaining a pneumatic pressure is arranged in an inner periphery of the carcass layer 7.

The bead portion 1 is provided on an outer side of the carcass layer 7 with a rim strip rubber 4 which comes into contact with a rim (not shown) at the time of installation of the rim. Further, the side wall portion 2 is provided on the outer side of the carcass layer 7 with a side wall rubber 9. In the present embodiment, each of the rim strip rubber 4 and the side wall rubber 9 is formed by a conductive rubber.

In the tread portion 3, a belt layer 6 constructed by a plurality of (two in the present embodiment) belt plies is arranged on the outer side of the carcass layer 7. Each of the belt plies is formed by coating a cord which extends while inclining with respect to the tire peripheral direction with a topping rubber, and is laminated in such a manner that the cord intersect inversely to each other between the plies. A belt reinforcing layer 8 formed by coating a cord which substantially extends in the tire peripheral direction with a topping rubber is arranged in an outer periphery of the belt layer 6, however, may be omitted as occasion demands.

In the tread portion 3, a tread rubber 10 is provided in outer periphery of the belt layer 6. The tread rubber 10 has a cap portion 12 which constructs a ground plane, and a base portion 11 which is provided on an inner side in the tire diametrical direction of the cap portion 12. The base 11 is made of a different kind of rubber from the cap 12.

As a raw material rubber of the rubber layer mentioned above, there can be listed up a natural rubber, a styrene butadiene rubber (SBR), a butadiene rubber (BR), an isoprene rubber (IR), an isobutylene isoprene rubber (IIR) and the like, and they are used independently or are used by mixing two or more. Further, the rubbers are reinforced by a filler such as a carbon black or a silica, and are appropriately blended with a vulcanizing agent, a vulcanization accelerator, a plasticizer, an antioxidant or the like.

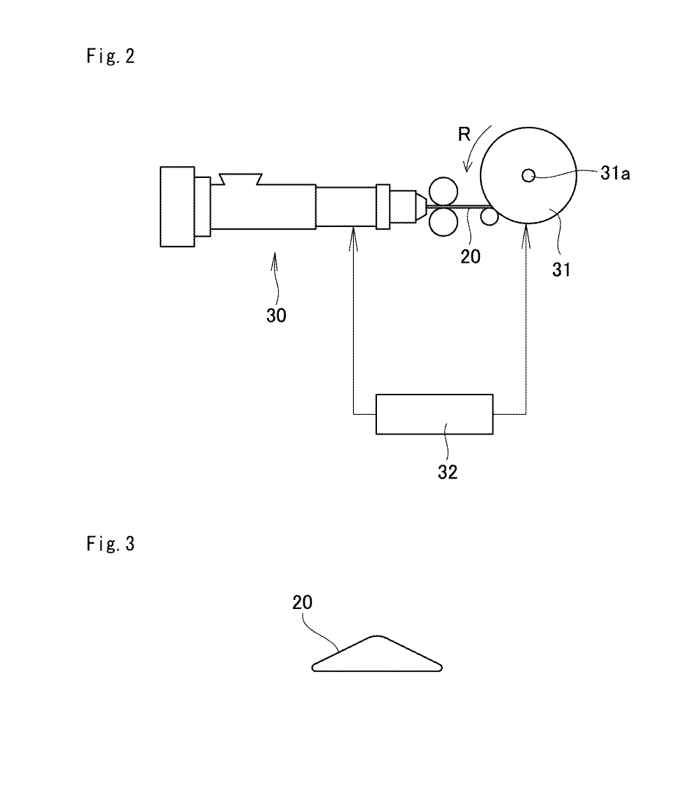

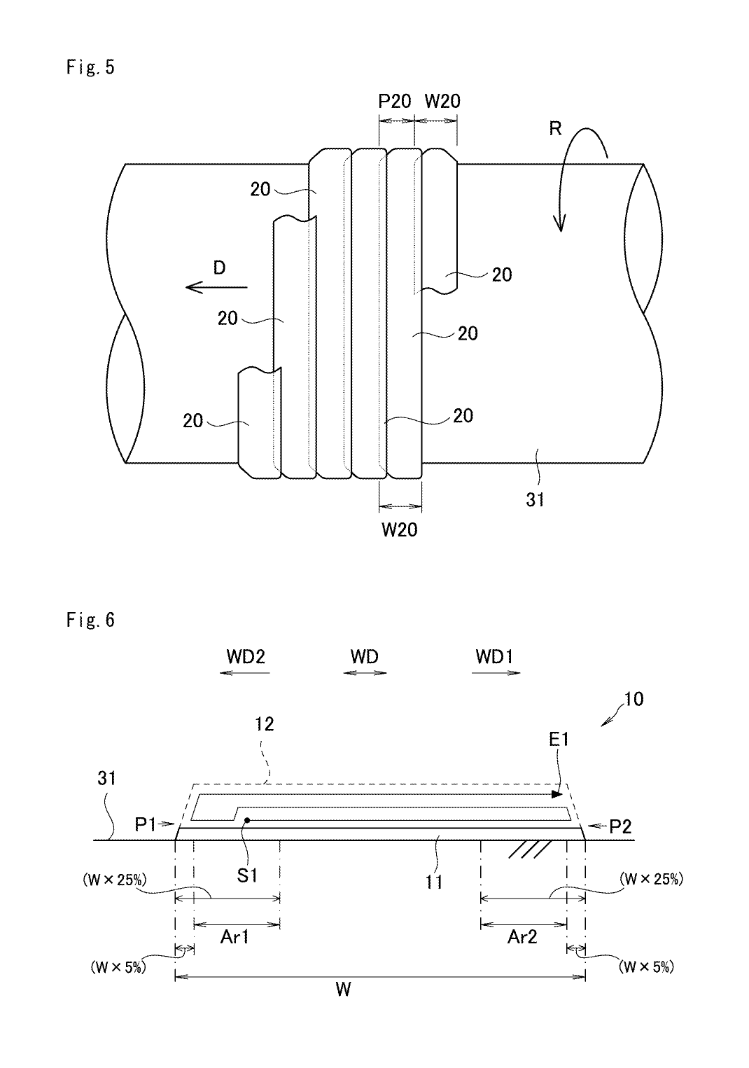

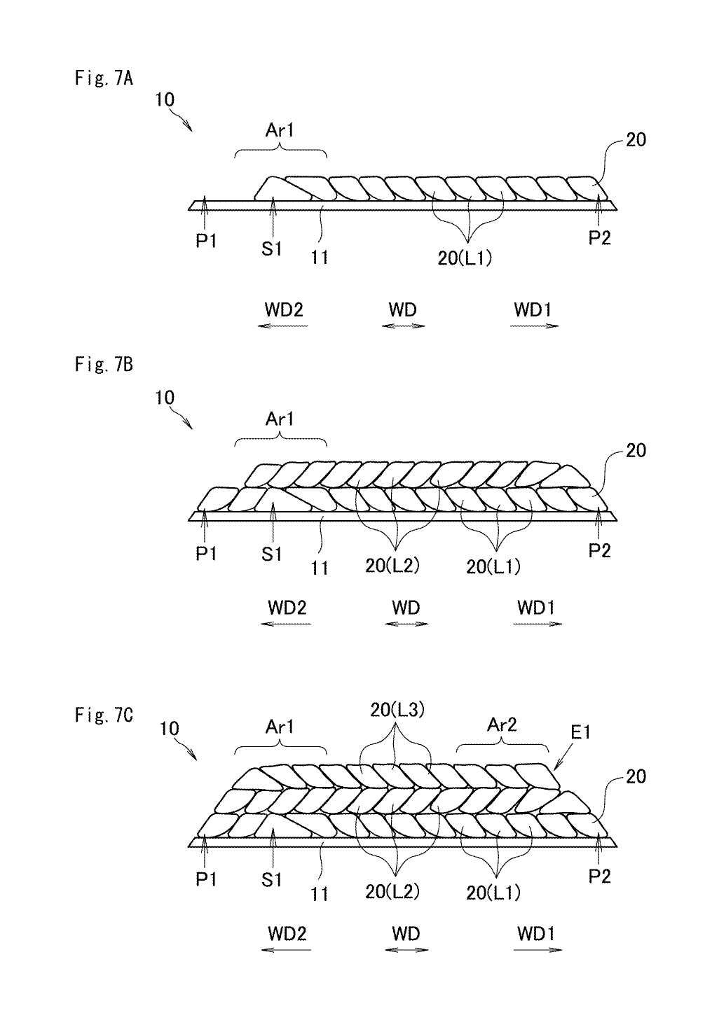

The tread rubber 10, particularly the cap portion 12 is formed by a so-called ribbon winding construction method. The ribbon winding construction method is a construction method for forming a rubber member having a desired cross sectional shape by spirally winding a narrow and unvulcanized ribbon rubber 20 shown in FIG. 3 around a tire rotating axis (refer to FIG. 2 and FIG. 5). The tread rubber 10 formed by the ribbon winding construction method has a winding start end S1 and a winding terminal end E1 of the ribbon rubber 20, as shown in FIG. 7C. The winding start end S1, the winding terminal end E1 and a moving route of a winding position can be checked out in a tire meridian cross section. Details thereof will be mentioned later.

Further, with a vulcanizing treatment being applied, a main groove 15 extending in the tire peripheral direction is formed on a surface of the tread rubber 10. A projection is provided in a tire mold which is used for the vulcanizing treatment, and the main groove 15 is formed by pressing the projection against the tread rubber 10. Thought an illustration will be omitted, the tread rubber 10 is appropriately provided with a transverse groove which extends in a direction intersecting the main groove 15.

[Manufacturing Method of Pneumatic Tire]

Next, a description will be given of a method of manufacturing the pneumatic tire T. Since the pneumatic tire T can be manufactured in the same manner as the conventional tire manufacturing method, except a point relating to the tread rubber 10, a description will be given mainly of a forming step of the tread rubber 10.

The tread rubber 10 shown in FIG. 1 is formed by the ribbon winding construction method. A forming step of the tread rubber 10 includes a stage which winds the ribbon rubber 20 supplied from a ribbon rubber forming device 30 to a rotation support body 31, while rotating the rotation support body 31, as shown in FIG. 2. The rubber ribbon 20 is formed by a nonconductive rubber, as shown in FIG. 3. A lower side in FIG. 3 comes to an inner peripheral side which is opposed to the rotation support body 31, at the winding time. A width and a thickness of the ribbon rubber (which may be called as a rubber strip) are not particularly limited, however, are preferably desirable to be set between 15 and 40 mm in width and between 0.5 to 3.0 mm in thickness.

As shown in FIG. 2, the ribbon rubber forming device 30 is structured so as to form the ribbon rubber 20 by extruding the rubber. The rotation support body 31 is structured so as to achieve a rotation in a direction R around an axis 31a, and a movement in an axial direction. A control device 32 carries out the operation control of the ribbon rubber forming device 30 and the rotation support body 31. In the present embodiment, across section of the ribbon rubber 20 is formed as a triangular shape, however, is not limited to this, but may be formed as the other shapes such as an oval shape, a quadrangular shape and the like. Further, the rotation support body 31 is structured so as to move in the axial direction, however, the ribbon rubber forming device 30 may be moved with respect to the rotation support body 31. In other words, it is possible to employ any structure as long as the rotation support body 31 can move relatively along the axis direction with respect to the ribbon rubber forming device 30.

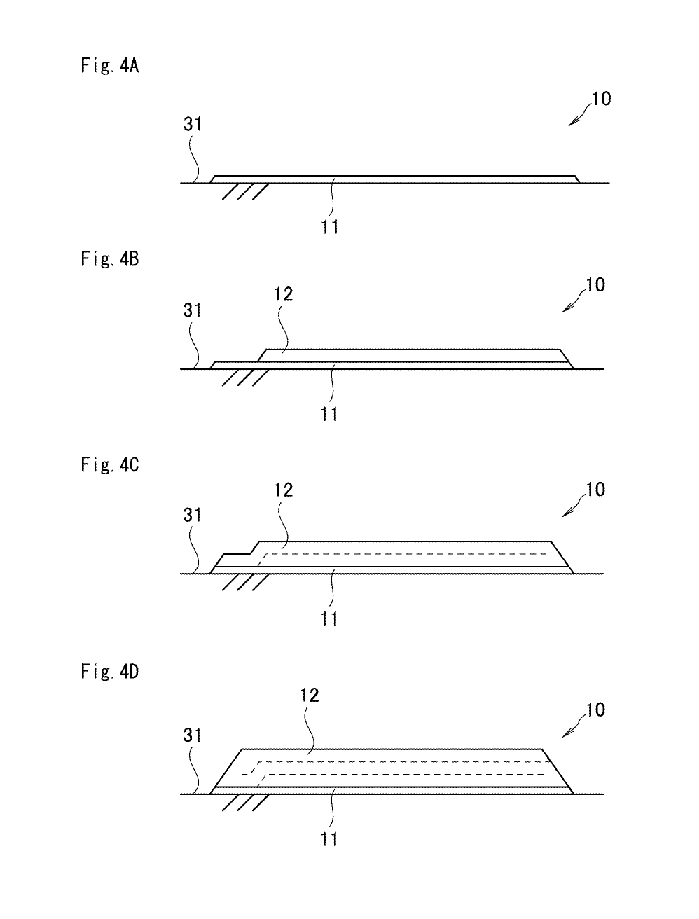

In the forming step of the tread rubber 10, first of all, as shown in FIG. 4A, the base portion 11 is formed in an outer peripheral surface of the rotation support body 31. Though an illustration will be omitted, the belt layer 6 and the belt reinforcing layer 8 are provided previously on an outer peripheral surface of the rotation support body 31 (refer to FIG. 1), and the base portion 11 is formed on them. The base portion 11 may be formed by any one of a so-called extrusion molding method and the ribbon winding construction method. The extrusion molding method is a construction method which has a step of extruding and molding an unvulcanized band-like rubber member having a desired cross sectional shape, and jointing end portions thereof so as to form annularly.

Next, as shown in FIGS. 4B to 4D sequentially, the cap portion 12 is formed on the outer peripheral surface of the base 11, and the tread rubber 10 shown in FIG. 1 is formed. In this case, as shown in FIG. 5, a winding pitch P20 of the ribbon rubber 20 is set to be smaller than a ribbon width W20 of the ribbon rubber 20. Accordingly, the adjacent ribbon rubbers 20 and 20 are spirally wound in a state of being in contact with each other. An arrow D indicates a moving direction of the ribbon winding position, and the adjacent ribbon rubbers 20 overlap their edge portions with each other along the direction.

FIG. 6 conceptually shows a moving route of the winding position of the ribbon rubber 20, in the forming step of the tread rubber shown in FIG. 4. As a matter of convenience for description, one side (a right side in the drawing) of the tire width direction WD in the tire meridian cross section is defined as WD1, and the other side is defined as WD2 (a left side in the drawing). The ribbon rubber is wound from the start point S1 which is positioned closer to the center side than tread ends P1 and P2 in the tire meridian cross section toward the tire width direction WD1 side. Next, the ribbon rubber is folded back to a tire width direction WD2 side at the tread end P2 closer to the WD1 side, and is wound toward the tread end P1 on the WD2 side beyond the start point S1. Next, the ribbon rubber is folded back to the tire width direction WD1 side at the tread end P1 in the WD2 side, and is wound toward the end point E1 which is positioned closer to the center side than the tread ends P2 and P2. Further, as shown in FIG. 6, in the case that a range between 5 and 25% of the maximum width W of the tread rubber from the tread ends P1 and P2 toward the center side is defined as tread end vicinity portions Ar1 and Ar2, the ribbon rubber has the winding start end S1 and the winding terminal end E1 in the tread end vicinity portions Ar1 and Ar2. 5% or more in the definition of the tread end vicinity portion means avoidance of the tapered tread end. Further, 25% or less means avoidance of the tread center portion, however, 20% or less is preferable for seeking out an improvement of the high-speed durability.

Specifically, the ribbon rubber 20 is wound, sequentially shown in FIGS. 7A to 7C. In this case, FIG. 7 is drawn conceptually, and a cross sectional area ratio of each of the ribbon rubbers 20 with respect to the tread rubber 10 may be smaller.

FIG. 7A corresponds to the stage in FIG. 4B, and the winding position of the ribbon rubber moves to the tire width direction WD1 side (the right side) by defining the tread end vicinity portion Ar1 on the tire width direction WD2 side (the left side) among the pair of tread end vicinity portions Ar1 and Ar2 as the start point S1, and reaches the tread end P2 on the tire width direction WD1 side (the right side). Accordingly, a first layer L1 of the ribbon rubber 20 is formed.

FIG. 7B corresponds to the stage in FIG. 4C, and the winding position of the ribbon rubber folds back to the tire width direction WD2 side (the left side) at the tread end P2 on the tire width direction WD1 side (the right side), goes over the start point S1, and reaches the tread end P1 on the tire width direction WD2 side (the left side). Accordingly, a second layer L2 of the ribbon rubber 20 is formed.

FIG. 7C corresponds to the stage in FIG. 4D, and the winding position of the ribbon rubber folds back to the tire width direction WD1 side (the right side) at the tread end P1 in the tire width direction WD2 side (the left side), reaches the tread end vicinity portion Ar2 in the tire width direction WD1 side (the right side), and defines this as the end point E1. Accordingly, a third layer L3 of the ribbon rubber 20 is formed.

As mentioned above, the pneumatic tire of the present embodiment is the pneumatic tire T in which the tread rubber 10 is formed by the ribbon rubber 20 spirally wound around the tire rotating axis, wherein the ribbon rubber 20 is wound toward the one side (WD1) in the tire width direction WD from the start point S1 which is positioned closer to the center side than the tread ends P1 and P2 in the tire meridian cross section, is next folded back to the other side (WD2) in the tire width direction WD at the tread end P2 on the one side (WD1), goes over the start point S1 so as to be wound toward the tread end P1 on the other side (WD2), is next folded back to the one side (WD1) in the tire width direction WD at the tread end P1 on the other side (WD2), and is wound toward the end point E1 which is positioned closer to the center side than the tread ends P1 and P2, and wherein the ribbon rubber 20 has the winding start end S1 and the winding terminal end E1 in the tread end vicinity portions Ar1 and Ar2 avoiding the tread ends P1 and P2 and the tread center portion.

Further, the pneumatic tire of the present embodiment is produced by the following manufacturing method. In other words, the manufacturing method of the pneumatic tire of the present embodiment is a manufacturing method of a pneumatic tire including a tread rubber forming step of forming the tread rubber 10 by spirally winding the ribbon rubber 20 around the tire rotating axis, wherein the tread rubber forming step includes a stage of winding the ribbon rubber 20 from the start point S1 which is positioned closer to the center side than the tread ends P1 and P2 in the tire meridian cross section toward the one side (WD1) in the tire width direction WD, next folding back the ribbon rubber to the other side (WD2) in the tire width direction WD at the tread end P2 on the one side (WD1), winding the ribbon rubber toward the tread end P1 on the other side (WD2) beyond the start point S1, next folding back the ribbon rubber to the one side (WD1) in the tire width direction WD at the tread end P1 on the other side (WD2), and winding the ribbon rubber toward the endpoint E1 which is positioned closer to the center side than the tread ends P1 and P2, and the ribbon rubber 20 has the winding start end S1 and the winding terminal end E1 in the tread end vicinity portions Ar1 and Ar2 avoiding the tread ends P1 and P2 and the tread center portion.

The tread end vicinity portions Ar1 and Ar2 mean a range between 5 and 25% of a tread rubber maximum width W from the tread ends P1 and P2 toward the center side.

According to the manufacturing method mentioned above, since the tread rubber 10 can be formed by one winding process without disconnecting the ribbon rubber 20 from the start point S1 to the end point E1, it is possible to improve a forming efficiency of the tread rubber 10. Further, since the winding start end S1 and the winding terminal end E1 of the ribbon rubber 20 are arranged at the tread end vicinity portions Ar1 and Ar2 avoiding the tread center portion, it is possible to reduce the influence of the centrifugal force and to improve the high-speed durability, in comparison with the case that the winding start end S1 and the winding terminal end E1 are arranged in the tread center portion. In addition, since the winding start end S1 and the winding terminal end E1 are arranged at the tread end vicinity portions Ar1 and Ar2 avoiding the tread ends P1 and P2, it is possible to appropriately push the ribbon rubber 20, and it is possible to suppress the defect.

Particularly, in the pneumatic tire of the present embodiment and the manufacturing method of the same, the ribbon rubber 20 forms the first layer L1 which reaches the tread end P2 on the other side (WD1) in the tire width direction by defining tread end vicinity portion Ar1 on the one side (WD2) in the tire width direction WD among the paired tread end vicinity portions Ar1 and Ar2 as the start point S1, next forms the second layer L2 which reaches the tread end P1 on the one side (WD2) beyond the start point S1 by folding back to the one side (WD2) in the tire width direction at the tread end P2 on the other side (WD1) in the tire width direction, and next forms the third layer L3 which defines the tread end vicinity portion Ar2 on the other side (WD1) in the tire width direction as the end point E1 by folding back to the other side (WD1) in the tire width direction at the tread end P1 on the one side (WD2).

According to the structure mentioned above, since it is possible to secure the thickness of the tread rubber 10 without narrowing the winding pitch P20 of the ribbon rubber 20 as well as raising the ribbon rubber 20, it is possible to improve both the securing of the thickness and the winding controllability of the ribbon rubber. Particularly, it is useful for forming the tire which requires the thickness such as the truck and the bus.

### Other Embodiments

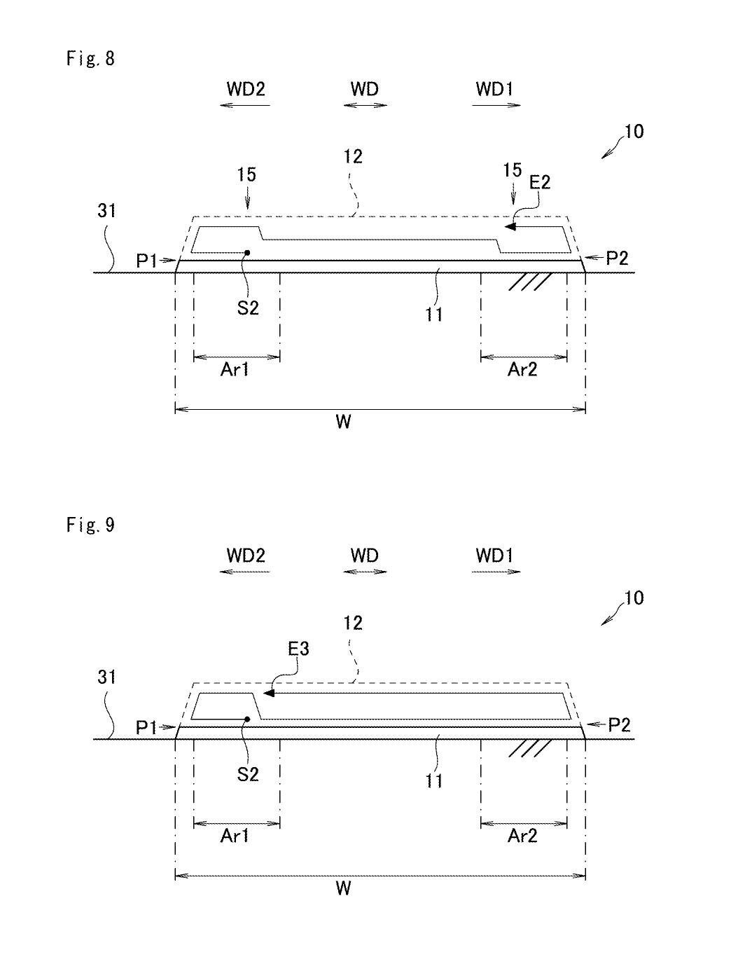

(1) The present invention is not limited to the present embodiment as long as the ribbon rubber 20 is wound without being disconnected on the way and the winding start end and terminal end are at the tread end vicinity portion. For example, the winding way shown in FIG. 8 is listed up. In other words, the winding position of the ribbon rubber 20 reaches the tread end P1 on the one side (WD2) in the tire width direction by defining the tread end vicinity portion Ar1 on the one side (WD2) as a start point S2, folds back to the other side (WD1) in the tire width direction at the tread end P1 so as to reach the tread end P2 on the other side (WD1) in the tire width direction beyond the start point S2, folds back to the one side (WD2) in the tire width direction at the tread end P2, reaches the tread end vicinity portion Ar2 on the other side (WD1), and defines the tread end vicinity portion Ar2 as a terminal end E2. In this example, the winding terminal end E2 of the ribbon rubber 20 is arranged at the forming position of the main groove 15 which extends in the tire peripheral direction, as shown in FIG. 8. In the forming position of the main groove 15, since the thickness of the rubber is reduced, and the heat generation at the time of the high-speed rotation is suppressed in conjunction therewith, it is possible to suppress the failure caused by the heat generation, and it is possible to further improve the high-speed durability.

(2) As a different winding method from the above method, a winding start end S2 and a winding terminal end E3 of the ribbon rubber 20 may be arranged only at the one tread end vicinity portion Ar1 among the paired tread end vicinity portions Ar1 and Ar2, as shown in FIG. 9.

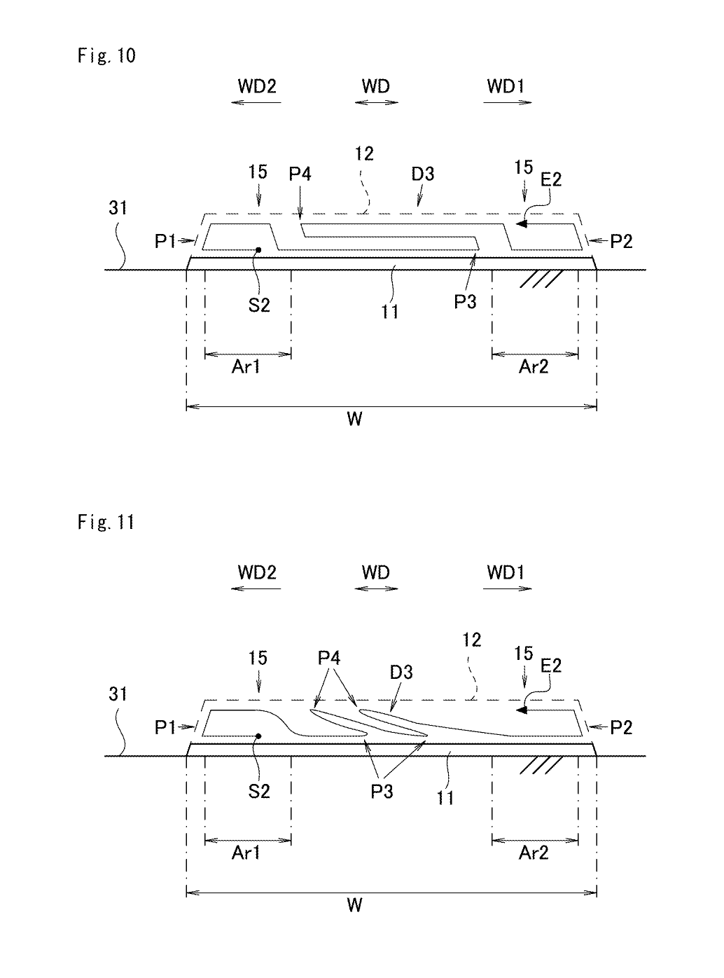

(3) As a different winding method from the above method, there can be listed up a structure in which the tread rubber has a three-layer structure portion D3 at a position which is closer to the center side than the tread ends P1 and P2, by folding back the ribbon rubber which is wound toward the one side (WD1) in the tire width direction at a position P3, winding toward the other side (WD2) in the tire width direction, thereafter folding back again at a position P4, and winding toward the one side (WD1) in the tire width direction, as shown in FIG. 10. According to the structure mentioned above, it is possible to easily secure the thickness of the tread rubber 10 without narrowing the winding pitch P20 of the ribbon rubber 20 as well as raising the ribbon rubber 20. In an example shown in FIG. 11, a plurality of three-layer structure portions D3 are formed.

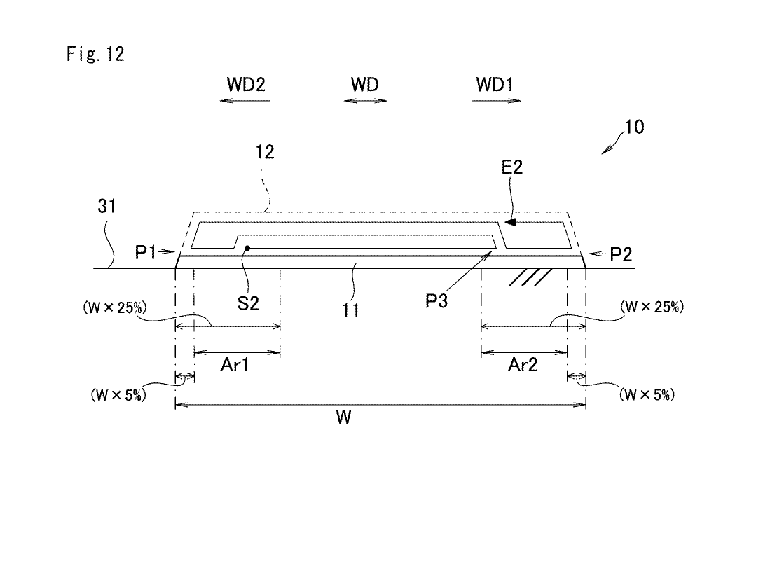

(4) As a different winding method from the above method, a winding method shown in FIG. 12 can be listed up. In other words, the ribbon rubber is wound toward the other side (WD1) in the tire width direction by defining the tread end vicinity portion Ar1 on the one side (WD2) as the start point S2. Next, the ribbon rubber is folded back at the position P3 so as to be wound toward the one side (WD2) in the tire width direction beyond the start point S2, is folded to the other side (WD1) in the tire width direction at the tread end P1 on the one side (WD2), and is wound toward the tread end P2 on the other side (WD1) beyond the start point S2. Next, the ribbon rubber is folded back at the tread end P2 on the other side (WD1), and is wound to the terminal end E2 which is positioned closer to the center side than the tread end P2. According to the structure mentioned above, since it is possible to keep the tread end P2 and the winding terminal end E2 away from each other by folding back the winding terminal end E2, it is possible to further reduce the problem caused by the movement of the winding terminal end E2 closer to the tread end P2. As one example of the problem, for example, there can be listed up a defect caused by a short pressing of the ribbon rubber by the following roller (stitcher).

Further, it is preferable that the winding start end S1 and the winding terminal end E1 are kept away at 180 degrees in the tire peripheral direction. In other words, since a radial force variation (RFV) is improved and a ground surface pressure distribution on a periphery becomes uniform as long as the winding start end S1 and the winding terminal end E1 are in a positional relationship which is symmetrical around the tire rotating axis, it is possible to improve the high-speed durability.

### EXAMPLES

A description will be given below of examples which effectively show the structure and the effect of the present invention. In this case, the high-speed durability was evaluated by using a test tire having a tire size 215/45R17. The high-speed durability was tested on the basis of a condition about tire of a speed mark H (210 km/h) which was defined as load/speed performance test procedure by a supplementary provision 7 of Regulation No. 30 of Economic Commission for Europe (Regulation No. 30 Uniform Provisions Concerning the Approval of Pneumatic Tires for Motor Vehicles and Their Trailers). The high-speed durability was evaluated by traveling at a high speed by a drum tester until the tire broke down, according to a method of increasing the traveling speed at 10 km/h per ten minutes. Therefore, the higher speed indicates the more excellent high-speed durability.

### Comparative Example

The tire was produced by arranging the winding start end of the ribbon rubber to the center portion in the tire width direction, winding the ribbon rubber like a infinity symbol shape, and arranging the winding terminal end at the center portion (the equator portion) in the tire width direction (refer to JP-A-2006-130880.

### Example 1

The tread rubber was formed by winding the ribbon rubber via the route shown in FIG. 6. The winding start end S1 and the winding terminal end E1 of the ribbon rubber 20 were arranged respectively at positions which were 12.5% of the maximum width W of the tread rubber from the tread ends P1 and P2 toward the center side. The same structures as the comparative example were applied except the above.

### Example 2

The tread rubber was formed by winding the ribbon rubber via the route shown in FIG. 8. The winding start end S2 and the winding terminal end E2 of the ribbon rubber 20 were arranged respectively at positions which were 20% of the maximum width W of the tread rubber from the tread ends P1 and P2 toward the center side. The same structures as the comparative example were applied except the above.

### Example 3

The tread rubber was formed by winding the ribbon rubber via the route shown in FIG. 9. The winding start end S2 and the winding terminal end E3 of the ribbon rubber 20 were arranged respectively at positions which were 24.1% of the maximum width W of the tread rubber from the tread end P1 toward the center side. The same structures as the comparative example were applied except the above.

### Example 4

The tread rubber was formed by winding the ribbon rubber via the route shown in FIG. 10. The winding start end S2 and the winding terminal end E2 of the ribbon rubber 20 were arranged respectively at positions which were 23.2% of the maximum width W of the tread rubber from the tread ends P1 and P2 toward the center side. The same structures as the comparative example were applied except the above.

### Example 5

The tread rubber was formed by winding the ribbon rubber via the route shown in FIG. 12. The winding start end S2 and the winding terminal end E2 of the ribbon rubber 20 were arranged respectively at positions which were 20% the maximum width W of the tread rubber from the tread ends P1 and P2 toward the center side. The same structures as the comparative example were applied except the above.

TABLE 1

| | Comparative | | | | | |
|---|---|---|---|---|---|---|
| | example | Example 1 | Example 2 | Example 3 | Example 4 | Example 5 |
| High-speed | 280 km/h | 310 km/h | 310 km/h | 300 km/h | 290 km/h | 300 km/h |
| durability | | | | | | |

In the comparative example, the failure was generated at 280 km/h, however, the speeds at which the failure was generated were higher in all the examples 1 to 5 than the comparative example. Accordingly, it is known that the high-speed durability is improved. In this case, it can be thought that the example 4 is lower in the high-speed durability in comparison with the examples 1 to 3 since the fold-back end of the ribbon rubber 20 exists at the tread intermediate portion between the paired tread end vicinity portions Ar1 and Ar2. Therefore, in the light of pursuit of the high-speed durability, it is thought to be preferable that the tread intermediate portion (including the tire equator) does not have any fold-back end.

It is possible to apply the structure employed in each of the embodiments to the other optional embodiment. The particular structure of each of the portions is not limited to the embodiments mentioned above, but can be variously modified within a range which does not deviate from the scope of the present invention.

What is claimed is:

1. A pneumatic tire comprising:
a tread rubber, the tread rubber being formed by a ribbon rubber which is spirally wound around a tire rotating axis,
wherein the ribbon rubber is wound from a start point which is positioned closer to a center side than tread ends toward one side in a tire width direction in a tire meridian cross section, is next folded back to the other side in the tire width direction at the tread end on the one side, is wound toward the tread end on the other side beyond the start point, is next folded back to the one side in the tire width direction at the tread end on the other side, and is wound toward a terminal end which is positioned closer to the center side than the tread ends, and
wherein the ribbon rubber has a winding start end and a winding terminal end in the vicinity of the tread ends avoiding the tread ends and the tread center portion.

2. The pneumatic tire according to claim 1, wherein the winding terminal end is arranged at a position at which a main groove extending in a tire peripheral direction is formed.

3. The pneumatic tire according to claim 1, wherein the tread rubber has a three-layer structure portion in which the ribbon rubber wound toward the one side in the tire width direction is folded back, is wound toward the other side in the tire width direction, is thereafter folded back again and is wound toward the one side in the tire width direction, at the position closer to the center side than the tread ends.

4. The pneumatic tire according to claim 1, wherein the ribbon rubber forms a first layer which has the vicinity portion of the tread end on the one side in the tire width direction as a start point, among the vicinity portions of the pair treads to the tread end on the other side in the tire width direction, next forms a second layer which is folded back to the one side in the tire width direction at the tread end on the other side in the tire width direction and reaches the tread end on the one side beyond the start point, and next forms a third layer which is folded back to the other side in the tire width direction at the tread end on the one side and has the vicinity portion of the tread end on the other side in the tire width direction as a terminal end.

5. A manufacturing method of a pneumatic tire, comprising:
a tread rubber forming step of forming a tread rubber by spirally winding a ribbon rubber around a tire rotating axis,
wherein the tread rubber forming step comprises a stage of winding the ribbon rubber from a start point which is positioned closer to a center side than tread ends in a tire meridian cross section toward one side in a tire width direction, next folding back the ribbon rubber to the other side in the tire width direction at the tread end on the one side, winding the ribbon rubber toward the tread end on the other side beyond the start point, next folding back the ribbon rubber to the one side in the tire width direction at the tread end on the other side, and winding the ribbon rubber toward a terminal end which is positioned closer to the center side than the tread ends, and
wherein the ribbon rubber has a winding start end and a winding terminal end in the vicinity portion of the tread end avoiding the tread end and the tread center portion.

6. The manufacturing method of the pneumatic tire according to claim 5, wherein the winding terminal end is arranged at the forming position of the main groove extending in the tire peripheral direction.

7. The manufacturing method of the pneumatic tire according to claim 5, wherein the three-layer structure portion is formed by folding back the ribbon rubber which is wound toward the one side in the tire width direction, at the position which is closer to the center side than the tread ends, winding the ribbon rubber toward the other side in the tire width direction, and thereafter folding back the ribbon rubber again so as to wind toward the one side in the tire width direction.

8. The manufacturing method of the pneumatic tire according to claim 5, wherein a first layer is formed by moving the winding position of the ribbon rubber to the tread end on the other side in the tire width direction from the start point of the vicinity portion of the tread end on the one side in the tire width direction, among the vicinity portions of the pair treads, a second layer is next formed by folding back the winding position of the ribbon rubber to the one side in the tire width direction at the tread end on the other side in the tire width direction and moving to the tread end on the one side beyond the start point, and a third layer is next formed by folding back the winding position of the ribbon rubber to the other side in the tire width direction at the tread end on the one side and defining the vicinity portion of the tread end on the other side in the tire width direction as a terminal end.
